(19) United States
(12) Patent Application Publication
(10) Pub. No.: US 2018/0366964 A1
(43) Pub. Date: Dec. 20, 2018

(54) UNIVERSAL BATTERY MOUNT FOR PORTABLE ELECTRIC POWER TOOL

(71) Applicant: Voung, Vui MU, Montdore (NC)

(72) Inventor: Voung, Vui MU, Montdore (NC)

(21) Appl. No.: 15/779,924

(22) PCT Filed: Nov. 28, 2016
(86) PCT No.: PCT/EP2016/078986

§ 371 Date: May 30, 2018

(30) Foreign Application Priority Data
Nov. 30, 2015 (FR) 1561540

(51) Int. Cl. H02J 7/00; B25F 5/02; H01M 2/10

(52) U.S. Cl. CPC H02J 7/0045; H01M 2220/30; H01M 2/1022; B25F 5/02

(57) ABSTRACT

Disclosed is a battery mount intended to supply power to a specific portable electric power tool with a rechargeable battery, including a shoe intended to hold a standard battery and a specific contact sole equipped with electrical connections that pass through it, this contact sole including, on one side, a standard face intended to fit onto the shoe, having a first end of the electrical connections arriving at the shoe or at the standard battery, and including on the other side, a specific face intended to fit onto the specific portable electric power tool, having a second end of the electrical connections coming into contact with the terminals of the tool.

This invention relates to a battery mount for a portable electric power tool as well as a portable electric power tool equipped with such a battery mount.

Self-contained portable electric power tools that are being more and more widely used constitute electric tools comprising a battery that makes it possible to work on site without using a connecting cable to an electrical supply grid.

It is thus possible to move anywhere on site without having to plug the apparatus into an electrical outlet and without using connecting cables that can be awkward or even dangerous by remaining in the way. Portable electric power tools can also be used on sites without electric power.

Currently, portable electric power tools with a large number of functions are available, comprising in particular drills, screwdrivers, jigsaws, circular saws, sanders, disc grinders or grinders. Portable electric power tools are produced by a large number of manufacturers, offering equipment for both amateurs and professionals, in different price ranges.

For a professional frequently using these portable electric power tools, it is standard to provide two batteries for each apparatus in order to be charging one when the other one is being used; this makes it possible to always have a charged power source that avoids stopping the tool.

One problem that arises for these tools is that the major manufacturers have each developed their battery types having a specific connection on their apparatus. Moreover, for the same manufacturer, there can be different types of batteries corresponding in particular to different charge capacities.

The professional using a certain number of portable electric power tools is then subject to a problem of the variety of battery models, in particular if he wants to optimize each type of apparatus in choosing it from among different builders to obtain the best speed and efficiency for his specific job.

The management of batteries for these different tools, with, if necessary, their replacement batteries, thus becomes complicated. In particular, different chargers are necessary to adapt to the battery types. It can be difficult to match the batteries for the entire stock of portable electric power tools.

Moreover, another problem can likewise arise when the batteries of aging tools are to be replaced; they may no longer be on the market or be too expensive with respect to the price of a completely new tool offered by the manufacturers. Consequently, this indirectly requires the users to favor a new tool and thus to get rid of their aging equipment that is, however, still serviceable.

Since these batteries have limited service lives, it is not possible to shift from a battery of one type of apparatus to the other if this battery is not compatible between two generations; this particularly complicates the management of the replacement of these components.

The object of this invention is in particular to avoid these defects of the prior art.

For this purpose, it proposes a battery mount that is designed to power a specific portable electric power tool with a rechargeable battery, this mount being noteworthy in that it comprises a shoe that is designed to hold a standard battery, and a specific contact sole that is equipped with electrical connections that pass through it, this contact sole comprising on one side a standard face designed to fit onto the shoe, having a first end of the electrical connections arriving at the shoe or at the standard battery, and comprising on the other side a specific face designed to fit onto the specific portable electric power tool, having a second end of the electrical connections making contact with the tool terminals.

One advantage of this battery mount is that in a simple manner, by providing several contact shoes that are each adapted to a specific type of tool, which can be economically produced, the same battery is then always used, which allows the use of a single standard model of the battery for a large variety of apparatuses.

The management of the batteries is then greatly simplified for the professional or the individual due to the standard model of the battery used; this makes it possible, for example, to provide a number of batteries that have been recharged in advance that is less than the number of apparatuses without the risk of coming up short. Moreover, this invention will be able to advantageously keep in service tools whose batteries are no longer available.

The battery mount according to the invention can, moreover, comprise one or more of the following characteristics, which can be combined with one another.

Advantageously, the shoe comprises parallel slides that are designed to accommodate and fix the battery in place.

In particular, the shoe and the contact sole each comprise a holding recess, these recesses being designed to accommodate a common locking latch.

Advantageously, the contact sole comprises contact blades passing through a sole plate, forming electrical connections.

In this case, the shoe can comprise independent contact blades of the electrical connections of the sole, which come into contact with these electrical connections.

Advantageously, the battery mount comprises parallel connecting slides of the sole on the shoe. The battery is easily and promptly fastened on the shoe.

According to one embodiment, the shoe comprises an electronic circuit that adapts the voltage supplied by the battery. In this way, the same battery can be fitted onto tools comprising different voltages.

According to one embodiment, the electronic circuit comprises a manual selector for adaptation of the supplied voltage.

According to another embodiment, the electronic circuit comprises an automatic means of adaptation of the supplied voltage.

In addition, the shoe can comprise a display that displays the voltage supplied to the specific tool. In this way, the voltage supplied by the battery can be regulated manually. As an option, the shoe can comprise an electrical outlet allowing the connection of a battery charger, which supplies the tool in the absence of a battery.

The object of the invention is also a portable electric power tool using a rechargeable battery comprising a battery mount comprising any one of the preceding characteristics.

Other characteristics and advantages will become apparent from the following description of the invention, given solely by way of example, with respect to the attached drawings in which:

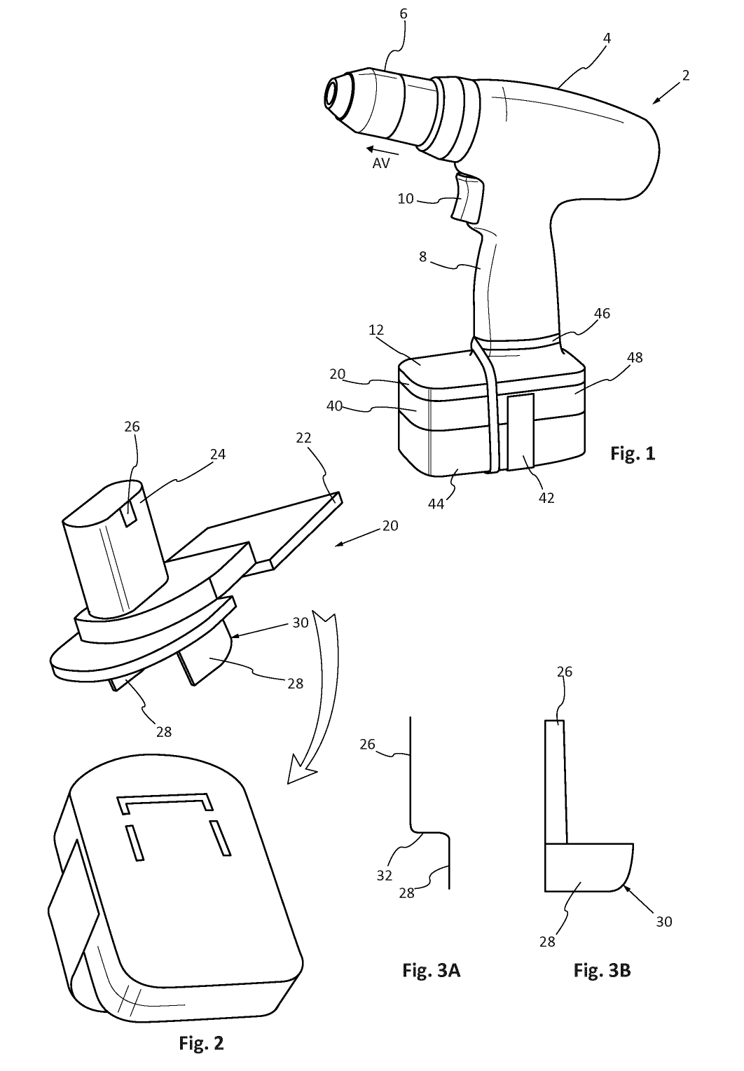

FIG. 1 shows a portable electric drill comprising a battery mount according to the invention;

FIG. 2 shows the mounting of the specific contact sole of this battery mount on its universal shoe;

FIGS. 3a and 3b show a contact blade of the electrical connections of the specific contact sole, in succession from the front and side;

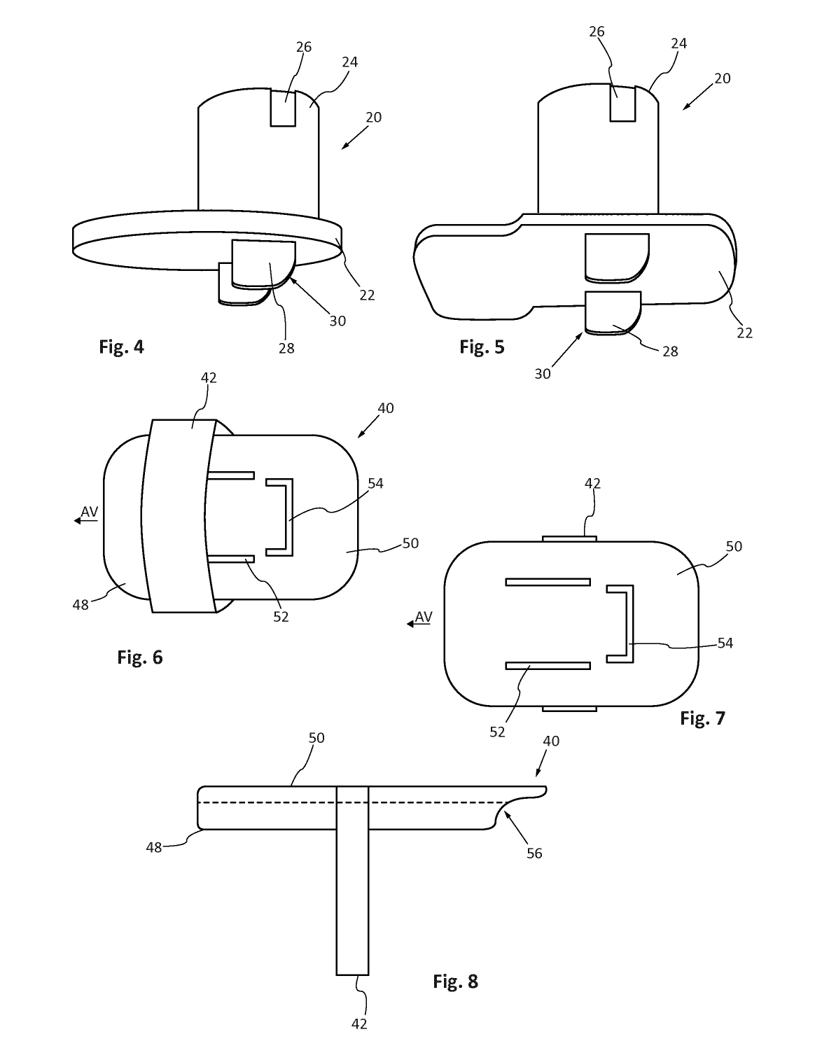

FIGS. 4 and 5 show two different specific contact soles;

FIG. 6 is a bottom view of the universal shoe;

FIGS. 7 and 8 show this shoe in a top view and side view respectively; and

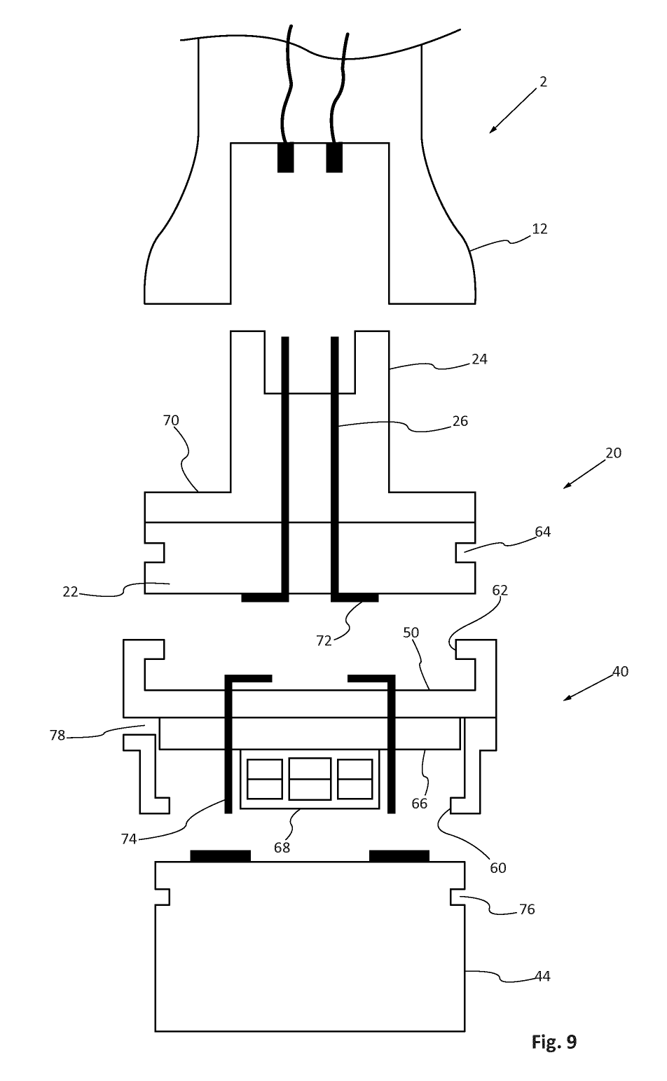

FIG. 9 shows in a vertical cutaway a battery mount according to one version.

FIG. 1 shows a portable electric drill 2 composed of a main body 4 containing a drive unit that drives a mandrel 6 located on the front side indicated by the arrow “AV.” The front-back direction is conventionally called the longitudinal direction. Conventionally, the tool is shown vertically, the tool being at the top, and the battery mount being at the bottom.

The main body 4 is extended underneath by a handle 8, having on an upper part a control trigger 10 that is located on the front side. The lower part of the handle 8 is extended by a wide base 12, comprising a flat base that forms a rectangle with rounded angles.

A specific contact sole 20 forms a plate attached underneath the wide base 12 of the handle 8, comprising a contour that is essentially fitted to the particular contour of this base.

A universal shoe 40 attached underneath the specific contact sole 20 comprises toward the bottom a horizontal adjusting belt 48 that is part of the battery strap that is standard 44, and a vertical holding belt 42 surrounding this battery to keep it in this shoe.

The battery 44 is said to be standard because it is designed to fit different types of portable electric power tools, comprising connections on batteries of different shapes. The universal shoe 40 is attached to the drill 2 by a strap 46 surrounding the wide base 12 of this drill in order to hold, without modifying the drill, the complete battery mount comprising the universal shoe 40 with its battery 44 as well as the specific contact sole 20, which are plated underneath this base.

FIG. 2 shows the specific contact sole 20 comprising an essentially flat sole plate 22 that fits the contour of the base 12 of the handle 8, comprising on the top a post 24 designed to fit into a corresponding housing underneath this base.

Two parallel contact blades 26 inserted vertically into the post 24 each have an upper part left free to come into contact with a terminal of the portable electric power apparatus 2 located in the handle 8 when the contact sole 20 is attached underneath, in order to establish an electrical connection to the drive unit of this apparatus.

Each contact blade 26 comprises a wide lower part 28 jutting out from underneath the sole plate 22, having a lower rounded side 30.

FIGS. 3a and 3b show a contact blade 26 comprising a horizontal part 32 that is formed by two 90° folds, located just above the lower wide part 28, supported underneath the sole plate 22 so as to be wedged on this plate, and to implement a spacing between the lower parts corresponding to that of the contacts of the battery 44.

The upper part of the contact blades 26 is adapted depending on the contact sole 20 that is specific to each type of tool, the lower part remaining constant because it is designed for the same standard batteries 44.

FIG. 4 shows one version of the specific contact sole 20 that has been adapted for a “Makita”-brand drill comprising a sole plate 22 having an oval contour of small length, and a post 24 of large width relative to this contour.

FIG. 5 shows one version of the specific contact sole 20 fitted for a “Ryobi”-brand drill comprising a sole plate 22 having a contour of great length and a post 24 of small width relative to this contour.

FIGS. 2, 6, 7 and 8 show a universal shoe 40 comprising a shoe plate 50 of rectangular contour comprising rounded edges, including on the front side and on the two lateral sides the horizontal adjusting belt 48 with a height of roughly 1 cm. The horizontal belt 48 ends toward the back of the lateral sides to be terminated by a concave roundness 56 returning toward the shoe plate 50 in order to allow the rear part of this belt to form a recess.

The vertical belt 42 forms a transverse strap with a width of roughly 1 cm, located in the middle of the universal shoe 40, comprising its ends attached on each side of the shoe plate 50 on the horizontal belt 48.

The standard battery 44 is inserted by the back into the horizontal belt 48, taking advantage of the recess of the rear part being left free to fit into the vertical belt 48 forming a buckle that holds it.

The shoe plate 50 comprises—symmetrically with respect to the longitudinal axis, toward the back—a holding recess 54 that forms a cutout of constant width with a transverse bar comprising on each end a small return motion that is turned toward the front.

The holding recess 54 present on the shoe and the sole is used to hold by clipping inside the battery 44, whose projecting part of the push latch is long enough to simultaneously “bite” one and the other when it is inserted toward the front into the universal shoe 40.

The shoe plate 50 comprises—symmetrically relative to the longitudinal axis—two slots parallel to this axis 52 that each accommodate in a fitted manner the wide lower part 28 of one contact blade 26. The rounded lower side 30 of this wide part 28 is used to facilitate insertion into connectors of the battery 44 in order to ensure electrical continuity of each pole of this battery via the contact blades 26, toward the terminals of the portable electric power apparatus.

In particular, the customer can buy a kit comprising the universal shoe 40 that is standard and the specific contact sole 20 that he has selected depending on its specific portable electric power apparatus; then he himself will assemble these two components with one another according to a mechanical locking system.

To do this, the kit includes an assembly means, comprising, for example, two supplied clamping screws.

In one version, the assembly means can comprise any other system, including, for example, clipping these two components with one another, which maintains the advantage of not requiring an additional component.

Moreover, the means of fastening the battery mount to the drill 2, consisting in this example of the strap 46 surrounding the handle 8, can comprise any other quick fastening system.

Advantageously, the universal shoe 40 and the contact sole 20 are formed by a plastic molding that makes it possible to economically implement complex shapes. In this way, a battery mount is implemented that is inexpensive, allowing a user in particular to provide a reduced number of standard batteries relative to a stock of portable electric power tools from different manufacturers or of different generations, due to the sharing of these batteries.

Likewise, portable electric power tools are identified, but this domain includes all portable apparatuses, such as, for example, vacuum cleaners, camping lanterns, electric vehicles for children or decanting pumps, i.e., all self-contained equipment including a battery or accumulator as a power source.

Depending on the types of apparatuses, it may also be that the number of contacts passing through the battery mount for connecting the battery to the apparatus varies according to the type of apparatus, but this is included in the current patent application, since it is enough to provide the corresponding number of contacts.

FIG. 9 shows a sole 20 comprising a sole plate 22 that is standard, accommodating at the top a specific adaptation 70 for a portable electric power tool 2, having the post 24 designed to fit into a corresponding recess of the base 12 of this tool.

The contact blades 26 pass through the sole 20, terminating underneath the sole plate 22 in a flat fold 72 under this plate.

On the top of a plate 50 on each side, the universal shoe 40 includes an upper slide 62 that fits into a groove 64 formed on one side of the sole plate 22 to ensure prompt mounting without using a tool. In particular, the upper slides 62 can be formed in a metal sheet fastened to the shoe implemented by a molding of a plastic material.

The shoe 40 comprises contact blades 74 that pass through it and that on the top have a flat fold supported on the corresponding fold 72 of the sole 20 when the shoe has been positioned. The base of the contact blades 74 arranged vertically fits into a connection of the battery 44 as it is being mounted.

The shoe 40 underneath on each side comprises a lower slide 60 that fits into a groove 76 formed on the side of the battery 44 to ensure prompt mounting without using a tool.

The shoe 40 comprises underneath its plate 50 an electronic system 66 that ensures in particular a modification of the voltage supplied by the battery 44 in order to adapt it to the voltage required by the tool 2.

In particular, manual adaptation of the voltage is possible using a manual control selector and a display 68 that shows the output voltage. Advantageously, the manual selector is mounted on the shoe 40 so as to no longer be accessible once the battery has been attached to the tool 2 that is ready to operate.

The shoe 40 on one side comprises an electrical outlet 78 that allows it to be connected to a battery charger that is connected to a power distribution grid in order to power the tool 2 without the battery 44 being inserted into the shoe.

In particular, in an integrated manner, the contact sole 20 can include the specific adaptation 70 and the sole plate 22 that are implemented in the same molding of a plastic material. In the same way, the shoe 40 can comprise its plate 50, the lower slides 60 and the upper slides 62 implemented in the same molding of a plastic material.

1. Battery mount designed to supply a specific portable electric power tool (2) with a rechargeable battery (44), the battery mount comprising: a shoe (40) that is designed to hold a standard battery (44), and a specific contact sole (20) that is equipped with electrical connections (26) that pass through it, this contact sole (20) comprising on one side a standard face that is designed to fit onto the shoe (40), having a first end (28) of the electrical connections (26) arriving at the shoe (40) or at the standard battery (44), and comprising on the other side a specific face designed to fit onto the specific portable electric power tool (2), having a second end of the electrical connections (26) coming into contact with the tool terminals.

2. Battery mount according to claim 1, wherein the shoe (40) comprises parallel slides (60) designed to accommodate and fasten the battery (44).

3. Battery mount according to claim 1, wherein the shoe (40) and the contact sole (20) each comprise a holding recess (54), these recesses being designed to accommodate a common locking latch.

4. Battery mount according to claim 1, wherein the contact sole (20) comprises contact blades passing through a sole plate (22), forming the electrical connections (26).

5. Battery mount according to claim 4, wherein the shoe (40) comprises independent contact blades (74) of the electrical connections (26) of the sole (20), which come into contact with these electrical connections.

6. Battery mount according to claim 1, wherein it comprises parallel connecting slides (62) of the sole (20) on the shoe (40).

7. Battery mount according to claim 1, wherein the shoe (40) comprises an electronic circuit (66) for adaptation of the voltage supplied by the battery (44).

8. Battery mount according to claim 7, wherein the electronic circuit (66) comprises a manual selector for adaptation of the supplied voltage.

9. Battery mount according to claim 7, wherein the electronic circuit (66) comprises an automatic means for adaptation of the supplied voltage.

10. Battery mount according to claim 1, wherein the shoe (40) comprises a display (68) that displays the voltage supplied to the specific tool (2).

11. Battery mount according to claim 1, wherein the shoe (40) comprises an electrical outlet (78) allowing the connection of a battery charger (44) that supplies the tool (2) in the absence of a battery.

12. Portable electric power tool using a rechargeable battery (44), wherein it comprises a battery mount according to claim 1.

13. Battery mount according to claim 2, wherein the shoe (40) and the contact sole (20) each comprise a holding recess (54), these recesses being designed to accommodate a common locking latch.

14. Battery mount according to claim 2, wherein the contact sole (20) comprises contact blades passing through a sole plate (22), forming the electrical connections (26).

15. Battery mount according to claim 3, wherein the contact sole (20) comprises contact blades passing through a sole plate (22), forming the electrical connections (26).

16. Battery mount according to claim 2, wherein it comprises parallel connecting slides (62) of the sole (20) on the shoe (40).

17. Battery mount according to claim 3, wherein it comprises parallel connecting slides (62) of the sole (20) on the shoe (40).

18. Battery mount according to claim 4, wherein it comprises parallel connecting slides (62) of the sole (20) on the shoe (40).

19. Battery mount according to claim 5, wherein it comprises parallel connecting slides (62) of the sole (20) on the shoe (40).

20. Battery mount according to claim 2, wherein the shoe (40) comprises an electronic circuit (66) for adaptation of the voltage supplied by the battery (44).
